(19) United States
(12) Patent Application Publication
(10) Pub. No.: US 2004/0144141 A1
(43) Pub. Date: Jul. 29, 2004

(54) Disc type padlock

(75) Inventor: William Ng, Hong Kong S. A. R. (CN)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(73) Assignee: Chateau Products, Inc., Bradenton, FL

(21) Appl. No.: 10/756,859

(22) Filed: Jan. 14, 2004

Related U.S. Application Data
(60) Provisional application No. 60/440,540, filed on Jan. 16, 2003.

(51) Int. Cl. E05B 67/28

(52) U.S. Cl. 70/48

(57) ABSTRACT

A disc shaped padlock has a shackle in the form of an open ring moveable in an arcuate groove within the body of the lock with a key to bring the opening in the ring into an aligned relation with a radially extending noted in the body to form an unlocked condition of the padlock. The opening in the ring is moved out of alignment with the notch to form a locked condition in which the notch is closed by the ring like shackle. The ring is provided with ball bearings in the outer surface to engage the arcuate groove to limit lateral movement of the shackle to insure smooth and easy movement of the shackle and to avoid noise often cause by a loose fit of shackles.

### REFERENCE TO RELATED APPLICATION

This application claims priority from U.S. Provisional Patent Application Serial No. 60/440,540 filed Jan. 16, 2003, the content of which is incorporated herein by reference.

### FIELD OF THE INVENTION

This invention relates to padlocks and more particularly to a padlock in which the shackle moves in an arcuate path relative to the body of the padlock.

### BACKGROUND OF THE INVENTION

Padlocks having shackles moveable in a circular or arcuate path are referred to as disc type padlocks and usually have a circular or disc shaped body with a notch in the circumference. The shackle which is arcuate or in the form of an open ring is completely concealed within the padlock body when in an open position and one end of the shackle extends to close the gap in the circular body near the circumference in a locked condition of the padlock. The gap at the circumference of the body is for the purpose of accepting the links of a chain or the eye of a hasp when the padlock is in an open or unlocked condition. The shackle is moved in an annular path through the operation of a key and tumbler mechanism to pass through a chain link or eye of a hasp to achieve the locked condition of the padlock.

The only connection between the open ring forming the shackle and the body of the padlock is the connection of the tumbler and the key with the shackle. As a consequence, both in its locked and unlocked condition, as well as during movement between those positions, the shackle tends to move laterally relative to the padlock body, often making a disturbing noise that causes the user to question the operation or integrity of the lock mechanism.

### SUMMARY OF THE INVENTION

It therefore is desirable to reduce any relative lateral motion of the arcuate shackle relative to the body to give a more firm and smooth operation to movement of the shackle and to minimize friction and any operational noises that might be found disturbing as the parts move relative to each other during movement between locked and unlocked positions.

It is an object of the invention to provide a disc type padlock in which the shackle is moveable between open and closed positions with a minimum of effort and in which the shackle is held firmly in position relative to the remaining parts of the padlock to eliminate noise or sounds of relative movement of the shackle and its body.

This and other objects of the invention are attained by a disc type padlock in which the open ring like shackle is provided with ball bearings that engage the walls of the padlock body to minimize any relative movement and contact and at the same time afford smooth quiet moving action between locked and unlocked positions. For this purpose the ring like shackle is provided with ball bearings strategically located and concealed within the housing body in both the locked and unlocked condition to minimize friction between the moving shackle and the padlock body and to hold the shackle firmly in position relative to the padlock body to minimize noise of its relatively moving parts.

### DESCRIPTION OF THE DRAWINGS

FIG. 1 is a photograph illustrating the front side of a disc shaped padlock embodying the invention shown in its unlocked condition;

FIG. 2 is a view similar to FIG. 1 showing the padlock embodying the invention in its locked condition and with the outer circumferential portion in cross-section;

FIG. 3 shows one side of the shackle separated from its supporting body; and

FIG. 4 is a cross-sectional view at an enlarged scale taken on line 4-4 in FIG. 2.

### DETAILED DESCRIPTION

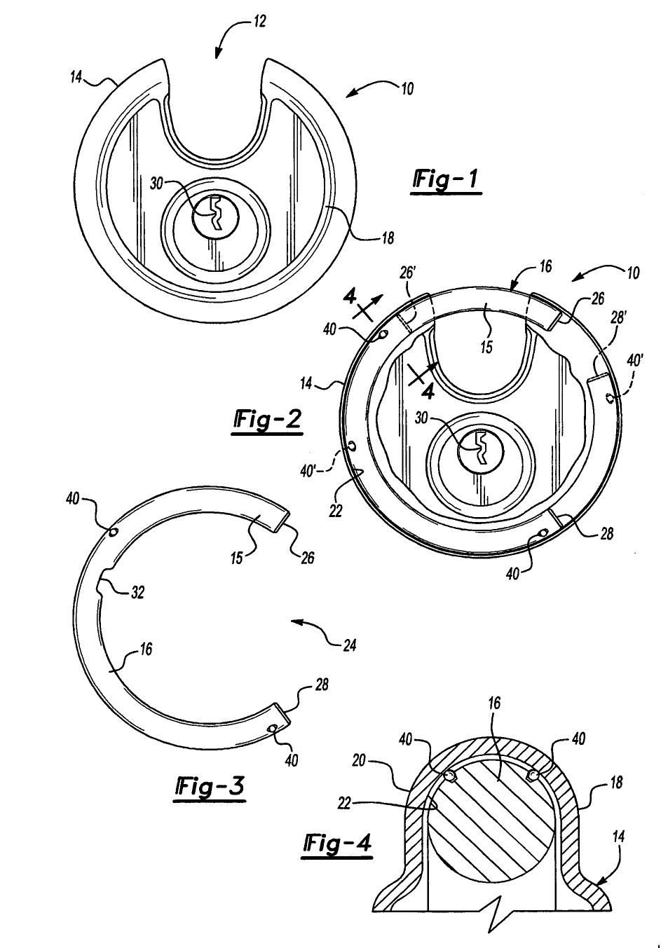

Referring to the drawings and particularly to FIG. 1, a disc type padlock is designated generally at 10 and is provided with a recess or notch 12 which is open at the circumference of the disc shaped body 14 in the illustrated unlocked condition of the lock. Notch 12 is closed by a portion 15 of a shackle 16 as seen in FIG. 1 in the locked position of the lock 10. In that position the shackle portion 15 is intended to receive portions of items to be locked or disabled such as hasps or chain links.

This invention is concerned with the relationship of the shackle 16 to the body 14 of the padlock 10 and a detailed description of the workings of the padlock are not needed for an understanding of the invention. A more complete disclosure of such locking mechanisms can be found in U.S. Pat. No. 4,998,423 to Hsu and U.S. Pat. No. 5,921,123 to Schwarzkopf.

Basically the padlock 10 is comprised of the body 14 which typically is formed in two parts such as a front portion 18 and a back portion 20 as seen diagrammatically in FIG. 4. The body portions are fastened together to form an internal annular groove 22 at the outer circumference of the circular body 14. The groove 22 is fitted with the shackle 16 which is slidably guided in the groove. Shackle 16 is in the form of an incomplete ring with a gap 24 between the opposite ends 26 and 28 as seen in FIGS. 2 and 3. In the locked position of the padlock 10 the portion 15 of shackle 16 closes the gap and the ends 26 and 28 of the shackle 16 are in a position shown in full line in FIG. 2 within the body member 14. In the unlocked position the ends 26 and 28 occupy the position shown at 26′ and 28′ in FIG. 2. The movement of the shackle 16 in its groove 22 is controlled by the lock mechanism (not shown) which is actuated by a key in a slot or keyway 30 indicated in FIGS. 1 and 2. The key typically operates a tumbler lock mechanism which engages the shackle 16 through a notch or the like 32 seen in FIG. 3. The notch 32 is positioned in the shackle between the pairs of bearings 40 and diametrically opposite the gap 24. Movement of the key causes the lock mechanism to move the shackle 16 between its open or unlocked position and its closed or locked condition.

In a preferred embodiment of the invention, the shackle 16 is provided with anti-friction bearing such as ball bearings 40. The bearings 40 are embedded in the surface of the shackle so that only a small surface portion protrudes to engage the walls of the internal groove 22 in the body 14 of the padlock 10. The bearings 40 are disposed in pairs to act against inner surfaces of groove 22. One pair of bearings 40 is disposed near the trailing end 28 of shackle 16. Another pair of bearings 40 are embedded in the surface of the shackle 16 in spaced relationship to the leading end 26 of the shackle 16 as best seen in FIG. 3. The two pairs of bearings 40 are disposed in diametrically opposed relationship to each other to facilitate support and alignment of shackle 16 relative to the surfaces of groove 16.

From an examination of FIG. 2, 3 or 4 it will be seen that the bearings 40 are positioned within the radially outer one half of the cross-section of the shackle 16. In that position the bearings 40 support the shackle 16 against lateral displacement.

When the lock is in its locked condition as illustrated in FIG. 2 both pairs of bearings 40 are disposed within and protected by the housing or body member 14. Also, as seen in FIGS. 2 and 3, the two pairs of bearings 40 are disposed in substantially diametrically opposed relationship and act in opposition to each other and theoretically are the only points of contact of the shackle 16 with the interior walls of the internal groove 22. During movement of the shackle 16, the bearings 40 serve to minimize surface friction and to bring about a smooth action in addition to maintaining the shackle 16 in close fitting relationship to the internal walls of the housing 14 so that noise or sounds are minimized in the locked position and during movement of the shackle between its locked position seen in FIG. 2 and its unlocked position seen in FIG. 1.

From an examination of FIG. 2 it will be noted that the end portions 26 and 28 of the shackle 16 are within the housing in the locked position as well as in the unlocked position indicated in broken line at 26′ and 28′. Similarly, the pairs of bearings illustrated at 40 in the locked position and the pairs of bearings denoted as 40′ indicating the unlocked position are always within the housing and in engagement with the inner surfaces of the internal groove 22.

The bearings 40 are embedded in the shackle 16 in a conventional manner by providing bored recesses as seen in FIG. 4 to receive the balls 40 and the edge surfaces of the recesses are upset or peened to hold the bearings in position. Once the shackle 16 is assembled in the lock housing or body 14, the bearings 40 can be maintained in position by their continuous contact with the interior surface of the internal groove 22.

It will be seen that the bearings 40 serve to maintain the principal points of contact of the shackle 16 with the body 14 of the lock 10 which serves to minimize friction during movement of the shackle 16 relative to the body 14 and also to suppress any sounds or noises between the shackle 16 and body member 14 that might be caused by a loose fit.

I claim:

1. A disc shaped padlock comprising:
a disc shaped body member forming an external notch extending radially through the circumference of said disc shaped body member and having a width sufficient to receive elements to be locked;
an internal groove formed at the circumference of said body member;
a shackle disposed in said groove of said body member, said shackle being in the form of an open ring having a gap at least equal to the width of said external notch, said shackle being in an unlocked position when said gap and said notch are aligned and in a locked position when said shackle has a portion closing the open end of said external notch; and
anti-friction bearings positioned in the surface of said shackle for engagement with the surface of said internal groove to limit transverse movement of said shackle relative to the internal surface of said internal groove during arcuate movement of said shackle between locked and unlocked positions.

2. The disc shaped padlock of claim 1 wherein said anti-friction bearings remain within said body member during movement between said locked and unlocked positions of said shackle.

3. The disc shaped padlock of claim 2 wherein a first bearing is positioned adjacent one end of said gap in said shackle and a second bearing is spaced from the other end of said gap in said shackle a distance more than the width of said external notch in said body member.

4. The disc shaped padlock of claim 2 wherein a first bearing is positioned in said shackle adjacent one end of said gap and a second bearing is positioned in said shackle diametrically opposed from said first bearing.

5. The disc shaped padlock of claim 2 wherein said anti-friction bearings are ball bearings.

6. The disc shaped padlock of claim 2 wherein each of said anti-friction bearings are ball bearings disposed in pairs with each bearing of each pair being disposed in the radially outer circumferential surface of said shackle to engage the surface of said internal groove and limit movement of said shackle relative to said groove.

7. The disc shaped padlock of claim 4 wherein a lock-engaging notch is formed in said shackle diametrically opposite said gap in said shackle.

8. The disc shaped padlock of claim 1 wherein said gap in said shackle is disposed between ends of said shackle and wherein both of said ends are within said body member in said locked and unlocked positions of said shackle.

9. A disc shaped padlock comprising:
a disc shaped body member forming an external notch extending radially through the circumference of said body member and having a width sufficient to receive elements to be locked;
an annular groove formed within and at the circumference of said body member;
a shackle disposed is said groove of said body member for movement in an annular path in said internal groove, said shackle being in the form of an open ring having a gap at least equal to the width of said external notch, said shackle being in an unlocked position when said gap and said notch are in alignment with each other and a locked position when said shackle has a portion closing said external notch; and
first and second bearings positioned in the surface of said shackle at first and second locations, respectively, for engagement with the surface of said internal groove, said first location being spaced from said one end of said gap in said shackle a distance greater than the width of said extended notch and said second location being diametrically opposed to said first location, said first and second locations being disposed within said housing during movement of said shackle between said locked and unlocked positions.

10. The disc shaped padlock of claim 9 wherein said first and second bearings are ball bearings.

11. The disc shaped padlock of claim 10 wherein said ball bearings are disposed in pairs at said first and second locations.

12. The disc shaped padlock of claim 9 wherein said first and second locations remain within said body member during movement between locked and unlocked positions of said shackle.

13. The disc shaped padlock of claim 9 wherein said first position is formed in said shackle adjacent in spaced relation to one end of said gap a distance greater than the width of said external notch and said second location as positioned in said shackle diametrically opposite from said first location.

14. The disc shaped padlock of claim 9 wherein said bearings are disposed in pairs with each bearing of each pair being disposed in a radially outer circumferential surface of said shackle to engage the inner surface of said internal groove and limit lateral movement of said shackle relative to said groove.

15. The disc shaped padlock of claim 9 wherein a lock-engaging notch is formed in said shackle between said first and said second locations and diametrically opposed to said gap.

16. The disc shaped padlock of claim 15 wherein both said first and second locations are within said body member in said locked and unlocked positions of said shackle.
